(19) United States
(12) Patent Application Publication
(10) Pub. No.: US 2011/0151303 A1
(43) Pub. Date: Jun. 23, 2011

(54) BATTERY MODULE

(75) Inventors: Jing-Yih CHERNG, Gueishan Township (TW); Chin-Ming Chen, Gueishan Township (TW); Xing-Fa Lin, Gueishan Township (TW)

(73) Assignee: AMITA TECHNOLOGIES INC LTD.

(21) Appl. No.: 12/821,233

(22) Filed: Jun. 23, 2010

(30) Foreign Application Priority Data
Dec. 23, 2009 (TW) 098224090

(51) Int. Cl. H01M 10/50

(52) U.S. Cl. 429/120

(57) ABSTRACT

A secondary battery module with waterproof and cooling functions includes a plurality of battery units and a waterproof shroud. The battery units are arranged by being interspaced to each other. Between any two adjacent battery units, a cooling channel is formed to be communicated to the external fluid. Every battery unit has an electrically conductive part. The waterproof shroud seals and covers the electrically conductive parts correspondingly. Thereby, the electrically conductive part of the battery unit is sealed, so a waterproof function is achieved and an excellent cooling efficiency of battery module is thus obtained.

### BACKGROUND OF THE INVENTION

1. Field of the Invention

The present invention in general relates to battery module, in particular, to a battery module with waterproof and cooling structure.

2. Description of Prior Art

Chargeable battery (or so-called “battery” and “secondary battery”) can be recharged with electricity. When a plurality of battery units are assembled into a battery device of high power by series or parallel connection, it can be adapted as a power source for a variety of appliances, for example, as a battery device for car or electric car.

According to prior arts, the structure of a chargeable battery includes a sealing shell and a plurality of single batteries. These single batteries are arranged by being closely adjacent to each other in the sealing shell; next, a battery lid is adapted to conductively connect these single batteries to form a battery module.

In aforementioned patents, since the rechargeable battery module is a package structure of closed type, there is no gap among these single batteries, which are closely adjacent to each other. When the battery module instantly outputs a large current, a high temperature will be generated. At this time, the generation speed of heat is substantially larger than the speed of cooling. When it is impossible to dissipate the waste heat in time, a safety doubt will be arisen in terms of usage, if the single battery unit is under a circumstance of high temperature too long. On the other hand, during the process of electric charge, the temperature generated from the single battery will be accumulated continuously in the outer shell of the battery. Therefore, in the long term of usage, the lifespan of the single battery will be shrunk. So, although the structure of a battery module of closed type can reach the function of waterproof, however, it is impossible to provide excellent cooling efficiency, which is an issue needed to be addressed urgently by the relative industry.

Accordingly, after a substantially devoted study, in cooperation with the application of relative academic principles, the inventor has finally proposed the present invention designed reasonably to possess the capability to improve the drawbacks of the prior arts significantly.

### SUMMARY OF THE INVENTION

Therefore, in order to solve aforementioned problems, the invention is mainly to provide a battery module sealing the electrically conductive part of battery unit, such that a waterproof function of the battery module is possessed.

Secondly, the invention is to provide a battery module, in which a cooling channel communicated to external fluid is formed between any two adjacent battery units, such that the battery module has an excellent cooling efficiency, because the waste heat generated in the battery unit can be dissipated quickly and in time.

Thirdly, the invention is to provide a battery module, including a plurality of battery units and a waterproof shroud. The battery units are arranged by being interspaced to each other. Between any two adjacent battery units, a cooling channel is formed to be communicated to the external fluid. Every battery unit has an electrically conductive part. The waterproof shroud seals and covers the electrically conductive parts correspondingly.

Compared to the prior arts, the waterproof shroud according to the present invention only seals the electrically conductive part of the battery unit, such that the battery module possesses a waterproof capability. On the other hand, since the battery units of the battery module are arranged by being interspaced to each other, a cooling channel communicated to external fluid is formed between any two adjacent battery units. By passing cooling gas or cooling liquid through the cooling channel from the outside, waste heat can be carried away quickly and in time. Therefore, under the premise of waterproof, the battery module is further benefited from an excellently cooling efficiency, enhancing the practicability of the invention.

### BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

FIG. 1 is a perspective outer illustration of a battery module according to the present invention;

FIG. 2 is a perspective explosive illustration of a battery module according to the present invention;

FIG. 3 is a cross-sectional view of the battery module of the invention, which has been assembled already; and

FIG. 4 is a battery module according to the second embodiment of the present invention.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

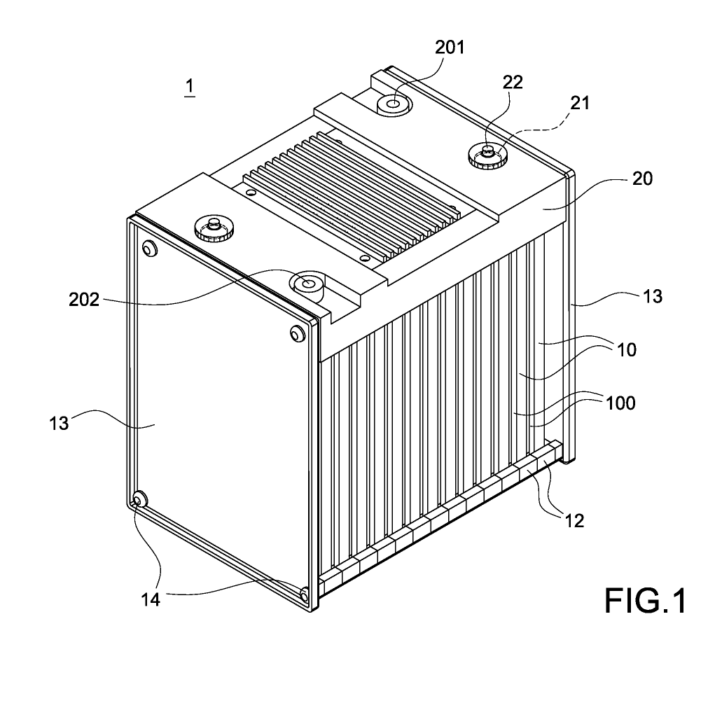

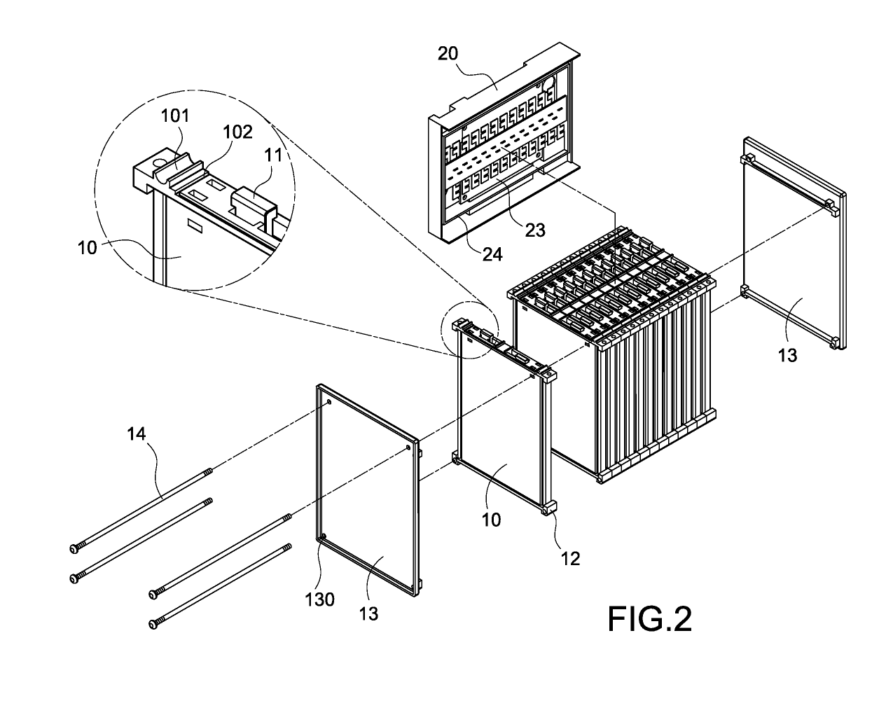

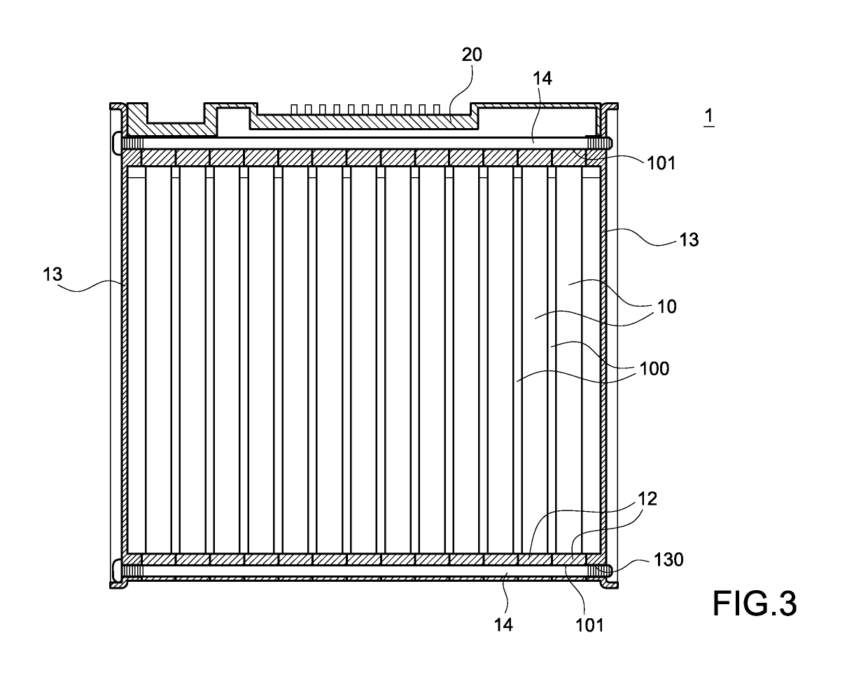

Please refer to FIG. 1 through FIG. 3, separately showing a perspective outer illustration, a perspective explosive illustration and a cross-sectional view of the assembly of the battery module according to the present invention. The battery module 1 of the invention includes a plurality of battery units 10 and a waterproof shroud 20.

The battery unit 10 can be a secondary battery of flexible package and includes at least one battery cell (not shown in the figures). These battery units 10 can be electrically connected in a series or parallel manner. During practical execution, the number of the battery unit can be increased when necessary. In this embodiment, the battery unit 10 has a rigid shell.

Every battery unit 10 has an electrically conductive part 11. Two spacers 12 are arranged respectively at two sides of the bottom face of the battery unit 10. In other words, the spacers 12 are respectively extended from two external sides of the battery unit 10 and vertical thereto. These battery units 10 are arranged by being interspaced to each other. By such arrangement of spacers 12, a cooling channel 100 is formed between any two adjacent battery units 10. When there is a high temperature occurred in the battery module 1, by passing cooling air or cooling liquid through the channels 100, the waste heat generated from the battery units 10 can be carried away quickly and in time.

A fixing plate 13 and a fixing rod 14 are respectively arranged at the outsides of these battery units 10. The arrangement of the fixing plate 13 can enhance the structural strength of the battery module 1 and protect these battery units 10 from the collision and damage caused by external objects. The fixing plate 13 and the battery unit 10 (having rigid shell) are respectively arranged at least one perforation 130, 101. The fixing rod 14 is arranged by passing through the perforations 130, 101, such that these battery units 10 are connected in series.

When covering over these battery units 10, the waterproof shroud 20 is fixed between the two fixing plates 13. The size of the waterproof shroud 20 is designed according to the quantity of these battery units 10. Meanwhile, a vent 21 is arranged at top face of the waterproof shroud 20 and has an exhaust valve 22 therein. When the temperature changes, the exhaust valve 22 can adjust the air volume in the waterproof shroud 20 in time, such that it can prevent the battery module 1 from the damage caused by the thermal expansion and contraction. Moreover, the battery module 1 is additionally arranged a circuit board 23, which is electrically connected to the electrically conductive parts 11 of these battery units 10 and is combined to the inside of the waterproof shroud 20. A positive electrode 201 and a negative electrode 202 are extended to the outside of the waterproof shroud 20.

In addition, on each of the top faces of the battery units 10, a groove 102 is arranged by enclosing each of the electrically conductive parts 11, while a sealing strip 24 is arranged on the inner bottom face of the waterproof shroud 20. During assembling process, the waterproof shroud 20 covers and seals each electrically conductive part 24 of the battery units 10; then, a sealing glue (not shown in the figures) is injected into the grooves 102; finally, the sealing strip 24 is inset fixedly in the grooves 102; thereby, the electrically conductive parts 11 of the battery units 10 are insulated from the external environment.

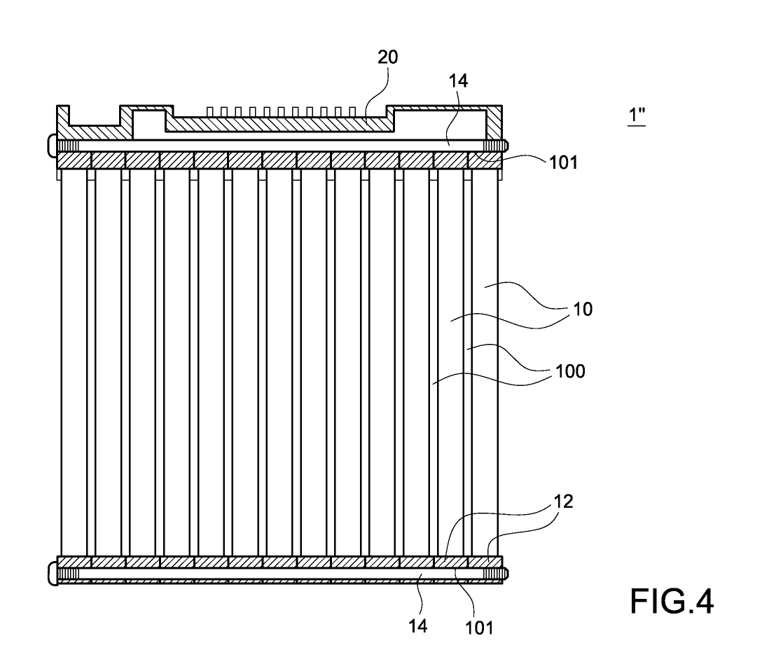

Please refer to FIG. 4, showing a battery module according to the second embodiment of the present invention. This embodiment is substantially same as the first embodiment, except that there is no fixing plate arranged at two external sides of the battery units 10 of the battery module 1′.

Therefore, through the constitution of aforementioned assemblies, a battery module according to the present invention is thus obtained.

Summarizing aforementioned description, the battery module according to the present invention is an indispensable structure for a secondary battery indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A battery module including:
a plurality of battery units which are arranged by being interspaced to each other, between any two adjacent battery units, a cooling channel being formed to be communicated to an external fluid, each battery unit having an electrically conductive part; and
a waterproof shroud which seals and covers the electrically conductive parts correspondingly.

2. The battery module according to claim 1, wherein the battery unit is a secondary battery having a flexible package.

3. The battery module according to claim 1, wherein the battery unit has a rigid shell.

4. The battery module according to claim 3, further including a fixing rod which is arranged by passing through a peroration arranged at the rigid body for connecting these battery units in series.

5. The battery module according to claim 3, wherein two spacers are respectively arranged at two sides of the battery unit by being extended from two lateral sides of the battery unit and vertical to two lateral faces of the battery unit as well, such that the spacers separate these battery units, while the cooling channel is formed between any two adjacent battery units.

6. The battery module according to claim 3, wherein a groove is arranged by surrounding the electrically conductive part of the battery unit, while a sealing strip is arranged on an inner bottom face of the waterproof shroud to be inset into the groove.

7. The battery module according to claim 1, further including a circuit board, which is electrically connected to the electrically conductive parts of these battery units and is combined to an inside of the waterproof shroud.

8. The battery module according to claim 1, wherein the waterproof shroud is arranged a vent, in which an exhaust valve is combined thereto.

9. The battery module according to claim 1, further including two fixing plates, each of which is respectively located at two external sides of these battery units, while the waterproof shroud covers over these battery units arranged between these two fixing plates.
